(19) United States
(12) Patent Application Publication
(10) Pub. No.: US 2025/0094523 A1
(43) Pub. Date: Mar. 20, 2025

(54) BENCHMARKING QUBO SOLVERS USING GENERATED PROBLEMS WITH KNOWN SOLUTIONS

(71) Applicant: Dell Products L.P., Round Rock, TX (US)

(72) Inventors: Miguel Paredes Quiñones, Campinas – SP (BR); Brendan Burns Healy, Haddonfield, NJ (US)

(21) Appl. No.: 18/466,915

(22) Filed: Sep. 14, 2023

(51) Int. Cl. G06F 17/11

(52) U.S. Cl. CPC G06F 17/11

(57) ABSTRACT

One example method includes creating a random matrix Q that defines a quadratic unconstrained binary optimization problem (QUBO) that has a known, optimal, solution, transmitting the random matrix Q to each solver in a group that includes multiple solvers, obtaining, from each of the solvers, a respective solution to the QUBO problem, benchmarking the solvers by comparing each of the solutions to the known, optimal solution and, based on the comparing, identifying a best solver from among the solvers in the group.

### FIELD OF THE INVENTION

Embodiments of the present invention generally relate to the solution of QUBO (quantum unconstrained binary optimization) problems. More particularly, at least some embodiments of the invention relate to systems, hardware, software, computer-readable media, and methods, for benchmarking QUBO solvers to identify which solver, among a group of solvers, may be expected to provide the best solution to a problem, such as a QUBO problem.

### BACKGROUND

Annealing processors, which may be referred to as “adiabatic optimizers” in some circumstances, specialize in solving problems referred to as QUBOs. Equivalently, annealing processors may take so-called “Ising” problems, although QUBOs and Ising problems are mathematically equivalent and can be automatically converted between them. Due to the rise in interest in quantum computing, quantum annealers have become especially popular in recent years, and are being offered by various providers, such as D-Wave for example.

As a result of the increasing prevalence of annealing processors, or simply “annealers,” more and more industry-scale problems have been converted into QUBO form in order to potentially take advantage of this new technology. Due to the growing library of applications, non-quantum, non-annealing solutions have become popular for evaluating QUBO problems, including both annealing simulations that run on CPU/GPU (central processing unit/graphics processing unit), such as OpenJIJ or dimod, as well as QUBO solvers, such as tabu search, that do not employ the principles behind annealing.

In terms of their ability to solve problems such as QUBOs, annealing processors fall somewhere between heuristic searches of the parameter space and exact solvers. For many problems, an annealer may perform significantly better than pure heuristic algorithms, but often will not converge on the optimal solution which can be found only by an exact solver. As such, it becomes important to be able to judge the output of these solvers, in order to be able to compare them against each other, and against a theoretical exact solver.

A naïve approach to solver evaluation might be to simply run the QUBO problem of interest on multiple devices and then compare the quality of the respective outputs of those devices. While this is possible, this approach fails to provide the ability to compare the respective outputs of the various devices against the theoretical optimal solution. For any problems of appreciable size, it is impossible to employ an exact solver because of the exponential scaling of the parameter space. Indeed, if it were possible, and feasible, to employ an exact solver for a particular problem, there would be no reason to use an annealer or simulated annealer.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a method according to one example embodiment.

FIG. 2 discloses aspects of a computing entity configured and operable to perform any of the disclosed methods, processes, and operations.

### DETAILED DESCRIPTION OF SOME EXAMPLE EMBODIMENTS

Embodiments of the present invention generally relate to the solution of QUBO (quantum unconstrained binary optimization) problems. More particularly, at least some embodiments of the invention relate to systems, hardware, software, computer-readable media, and methods, for benchmarking QUBO solvers to identify which solver, among a group of solvers, may be expected to provide the best solution to a problem, such as a QUBO problem.

In general, an embodiment of the invention may leverage the fact that a solver evaluation can be performed without necessarily requiring the solvers to run the actual QUBO problem, that is, the real-world QUBO problem needed to be solved, as part of the evaluation process. In particular, a method according to one embodiment, which may be concerned solely with benchmarking, does not run the QUBO problem in order to solve a real-world business case. Rather, in a benchmarking process according to one embodiment of the invention, a QUBO problem is created for a particular pre-defined optimal solution, that is, this QUBO problem is created specifically for the purpose of benchmarking one or more solvers. This QUBO problem may then be provided to one or more annealers and/or other solvers of a group. The respective outputs of the various annealers/solvers may then be compared to the known optimal solution of the QUBO problem, and an annealer/solver selected based on the outcome of the comparison. For example, the annealer/solver that generated a solution closest to the known solution may be selected to run the actual QUBO problem needed to be solved.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that an optimal QUBO solver for a given QUBO problem may be identified without requiring that the QUBO problem actually be run on the optimal QUBO solver as part of an evaluation process. An embodiment of the invention may enable an optimal QUBO solver for a given QUBO problem to be identified even when it would be impractical, such as because a parameter space of the QUBO problem is too large, to run the QUBO problem on multiple different solvers as part of an evaluation process. Various other advantages of one or more example embodiments will be apparent from this disclosure.

### A. Context for an Example Embodiment of the Invention

Annealing processors, such as D-WAVE (McGeoch and Farré 2020) and the photonic processer Dirac produced by Quantum Inc. Computing (see https://www.quantumcomputinginc.com/hardware/), for example, when evaluating any problem, require that the problem first be converted into a specific format to enable the problem to be executed on this highly specialized kind of hardware. This kind of problem is called a Quadratic Unconstrained Binary Optimization (QUBO) problem. These problems involve optimizing a quadratic polynomial in some number of variables that are binary, that is, they can only take the value 0 or 1, and are unconstrained, for example, all the variables may be 1, all may be 0, or may be any combination of 1 and 0.

One mathematical formulation of this problem is shown below where Q represents a matrix containing the coefficients of a degree two polynomial in variables x_i, the vector of which is x:

$${min}_{x ∈ {\{ 0 , 1 \}}^{n}} {x}^{T} Qx$$

Despite this limitation, many problems of interest, including NP-hard (non-deterministic polynomial time-hard) such as the so-called “Traveling Salesman” problem, may be expressed as QUBOs, enabling the usage of such architectures in real-world applications.

Consider the following example of this problem format in which there are two binary variables x1 and x2, and the quadratic polynomial P (x1, x2). The aim may be to determine what the minimal value of the quadratic polynomial is over the range of possible inputs, in this case, the inputs {(0,0), (1,0), (0,1), (1,1)}. Note that if the aim is to maximize a particular value instead, the polynomial P may simply be multiplied by −1. Suppose P=−3×1−5×2+10×1×2. Notice there is no lack of generality in the absence of x1\hat{ }2 or x2\hat{ }2 terms-note further that no matter whether xi is 0 or 1, it is true that xi=xi\hat{ }2, so axi+bxi\hat{ }2 may be rewritten as (a+b) xi\hat{ }2.

For the purposes of this illustrative case, it is relatively easy to obtain the solution by brute force, but note that the way the annealer calculates this optimization is relatively quicker than a brute force approach, in the case of a quality annealer and a larger problem, as disclosed elsewhere herein:

$$P ( 0 , 0 ) = 0 , P ( 1 , 0 ) = - 3 , P ( 0 , 1 ) = - 5 , P ( 1 , 1 ) = + 2$$

Therefore, in this example, the optimal solution arises from x1=0, x2=1.

### B. Detailed Description of an Example Embodiment of the Invention

### B.1 Background

In an earlier approach, the inventors performed benchmarking of quantum and non-quantum annealers using random QUBOs without known solutions. That effort involved generating polynomials by randomly selecting coefficients for xᵢ xⱼ terms from a predetermined range. Furthermore, the rate at which these coefficients were nonzero was selected in advance in order to emulate a QUBO of a specified density, such as 0.2 for example, meaning that 20% of possible coefficients were nonzero. However, this approach did not provide any information on the best possible solution, which in turn prevented checking the performance of the annealer. That is, there was no benchmark available against which the performance of the annealer could be checked. In theory, a brute force approach could have been used, but was not feasible given that the sizes of the problems being considered used 10,000-20,000 binary variables.

### B.2 Discussion

A benchmarking process as disclosed herein may improve the accuracy of solutions obtained to QUBO problems by identifying a annealer that provides the best performance, in terms of solution accuracy, as among a group of annealers to which a benchmarking QUBO problem has been submitted. A real world QUBO problem may then be submitted to the best performing annealer, with the expectation that the solution to the real world QUBO problem generated by that best performing annealer will be the most accurate solution that could be obtained, as compared with the respective solutions that would be expected to be provided by the other annealers in the group.

An embodiment of the invention is based on the result of the spectral theorem that states that the global minima of the Rayleigh quotient x^{T} Qx/x^{T} x is equal to the smallest eigenvalue of the QUBO matrix Q. Then:

$${λ}_{min} = {min}_{x} {x}^{T} Qx / {x}^{T} x ;$$

$${v}_{min} = {argmin}_{x} {x}^{T} Qx / {x}^{T} x$$

where vₘᵢₙ is the minimum eigenvector associated with the minimum eigenvalue λₘᵢₙ.

An embodiment of the invention comprises the following steps for creating a random matrix Q with size N×N with known solution x* and energy eₘᵢₙ:
1. Create a random binary vector x* of size N which will be the pre-defined solution—this can be done in multiple ways—for example by randomly selecting positions where the ones will be on an initially all zeros vector;
2. Calculate the null space matrix P of the vector x*—this can be done using techniques as Gauss-Jordan elimination or other efficient procedures;
3. Generate randomly a vector λ of real values with size N in a desired interval, these values will be the eigenvalues—then, order the entries λ by size and, finally, create the diagonal matrix Λ=diag(λ);
4. Create matrix D with vector x*/x*^{T} x* in the first row and the other null space columns from matrix P:

$$D = [ \begin{matrix}{x}^{* T} / {x}^{* T} {x}^{*} \\ {P}^{T}\end{matrix} ]$$

5. Then the final QUBO matrix will be Q=D^{T}ΛD/x*^{T} x*, and using an equivalence of the minimization of the Rayleigh quotient:

$${e}_{min} = {λ}_{1} / {x}^{* T} {x}^{*} = {min}_{x} {x}^{T} Q x$$

Since λ₁ and x*^{T} are known values, it is possible to calculate eₘᵢₙ—then the solution pair is (eₘᵢₙ, x*^{T}); and
6. Send the matrix Q to the desired annealers for benchmarking and once the respective solutions generated by the annealers are obtained, the solutions can be compared against the optimal solution pair (eₘᵢₙ, x*^{T})—the annealer that generated the solution closest to the optimal solution is the best annealer for solving this problem—note that as used in this particular example, the “best” solution refers to the most accurate solution, but may not necessarily imply the solution with the shortest execution time, for example.

To alleviate the computational burden of multiplying large matrices, such as are encountered in QUBO problems with a large number of binary variables, it is possible to use sparse matrix representation for all matrices and vectors used an embodiment of the invention. Put another way, an embodiment of the invention comprises a benchmarking approach that may be employed for identifying a “best” annealer to solve large and complex problems, even though, in one embodiment, such problems are not, themselves, solved as part of the benchmarking process.

### C. Example Methods

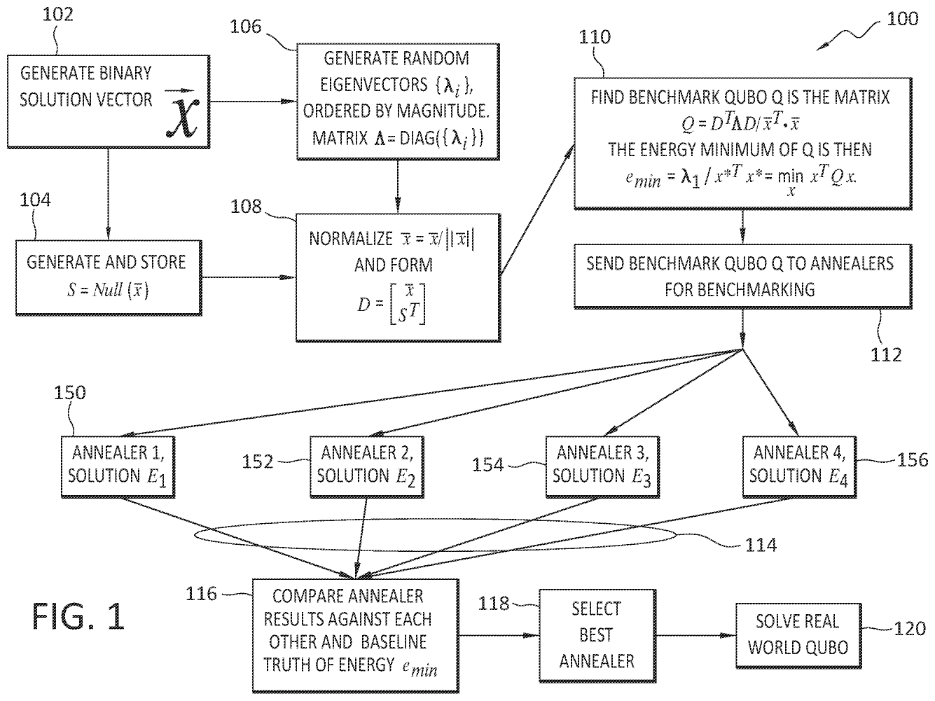

It is noted with respect to the disclosed methods, including the example method of FIG. 1, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 1, an example method according to one embodiment of the invention is referenced at 100. In an embodiment, the method 100 may be implemented in whole or in part by a special purpose computing system, such as an annealer benchmarking system, that is operable to communicate with one or more annealers in a group of annealers for the purpose of benchmarking the performance of those annealers. In general, performance of the method 100 may result in the creation of a random matrix Q with size N×N with known solution x* and energy eₘᵢₙ.

The example method 100 may begin with the creation 102 of a random binary solution vector. Next, a null space matrix of the random binary solution vector may be calculated and stored 104. As well, random eigenvectors may be generated 106 and ordered by their respective sizes. The operation 106 may also comprise the creation of a diagonal matrix that includes the eigenvectors. Note that the operations 104 and 106 may be performed in any order, relative to each other, or at the same time.

In any case, after the operations 104 and 106 have been performed, another matrix is generated 108 that includes the vector x*/x*^{T}x* in the first row, and the other null space columns from the null space matrix created 104 earlier. The final QUBO matrix is then generated and eₘᵢₙ is calculated 110.

With the solution to the benchmark QUBO problem now known, the benchmark QUBO problem may then be sent 112 to various annealers 150, 152, 154, and 156. Each of the annealers 150, 152, 154, and 156 may then generate its own respective solution to the benchmark QUBO problem and the annealers 150, 152, 154, and 156 may then send their solutions 114 to a comparator or other device which may then compare 116 the various solutions to each other, and to the pre-defined optimal solution of the QUBO problem.

Based on the comparing 116, the best annealer may then be selected 118. The best annealer may be the annealer whose solution to the benchmark QUBO problem is closest to the pre-defined optimal solution of the benchmark QUBO problem. When the best annealer has been selected 118, then a real world QUBO problem may be submitted to, and solved by, the best annealer 120. As noted earlier, even if the real world QUBO problem is relatively complex, such as the example with 10,000-20,000 binary variables, the best annealer may provide the best solution, relative to the solutions provided by the other annealers in a group that includes the best annealer, to that real world QUBO problem.

### D. Further Example Embodiments

Following are some further example embodiments of the invention. These are presented only by way of example and are not intended to limit the scope of the invention in any way.

Embodiment 1. A method, comprising: creating a random matrix Q that defines a benchmark quadratic unconstrained binary optimization problem (QUBO) that has a known, optimal, solution; transmitting the random matrix Q to each solver in a group that includes multiple solvers; obtaining, from each of the solvers, a respective solution to the benchmark QUBO problem; benchmarking the solvers by comparing each of the solutions to the known, optimal solution; and based on the comparing, identifying a best solver from among the solvers in the group.

Embodiment 2. The method as recited in any preceding embodiment, wherein one or more of the solvers comprises a respective annealer.

Embodiment 3. The method as recited in any preceding embodiment, wherein the identified solver is used to solve another QUBO problem.

Embodiment 4. The method as recited in any preceding embodiment, wherein the random matrix Q has a size N×N, and the known, optimal solution comprises a random binary vector x* of size N.

Embodiment 5. The method as recited in any preceding embodiment, wherein a smallest eigenvalue of the matrix Q is equal to a global minima of the Rayleigh quotient.

Embodiment 6. The method as recited in any preceding embodiment, wherein creating the random matrix Q comprises: creating a random binary vector x\hat{ }* of size N as the known, optimal solution; calculating a the null space matrix P of the random binary vector x*; randomly generating a vector λ of real values with size N in a defined interval, where the real values comprise respective eigenvalues, ordering the entries λ by size, and creating a diagonal matrix Λ=diag(λ); creating a matrix D with vector x*/x*^{T} x* in a first row of the matrix D, and other null space columns in the matrix D from the null space matrix P, where the matrix D has the form:

$$D = [ \begin{matrix}{x}^{* T} / {x}^{* T} {x}^{*} \\ {P}^{T}\end{matrix} ] ;$$

defining a final QUBO matrix Q=D^{T}ΛD/x*^{T} x*, then using an equivalence of a minimization of the Rayleigh quotient to calculate eₘᵢₙ as follows,

$${e}_{min} = {λ}_{1} / {x}^{* T} {x}^{*} = {min}_{x} {x}^{T} Qx ;$$

and
wherein eₘᵢₙ is calculated using known values λ₁ and x*^{T} to generate the known optimal solution, and the known optimal solution comprises a solution pair (eₘᵢₙ, x*^{T}).

Embodiment 7. The method as recited in claim 6, wherein calculating the null space matrix P is performed using Gauss-Jordan elimination.

Embodiment 8. The method as recited in any preceding embodiment, wherein the best solver is the solver whose solution is closest, relative to the respective solutions of the other solvers in the group, to the known, optimal, solution.

Embodiment 9. A system, comprising hardware and/or software, operable to perform any of the operations, methods, or processes, or any portion of any of these, disclosed herein.

Embodiment 10. A non-transitory storage medium having stored therein instructions that are executable by one or more hardware processors to perform operations comprising the operations of any one or more of embodiments 1-8.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed. In an embodiment, a computer and computing system may comprise quantum computing hardware, classical computing hardware, or a combination of the two. Quantum computing hardware may comprise, but is not limited to, annealers or annealing devices, gate-based quantum devices such as in the form of a quantum circuit, a quantum annealer, and real quantum hardware. Other hardware comprises a simulation engine, such as a simulated annealing device, that simulates actual hardware and is operable to obtain a resolution to a problem such as a QUBO for example. Other annealers, annealing devices, and other solvers, may comprise classical computing hardware and/or quantum computing hardware.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

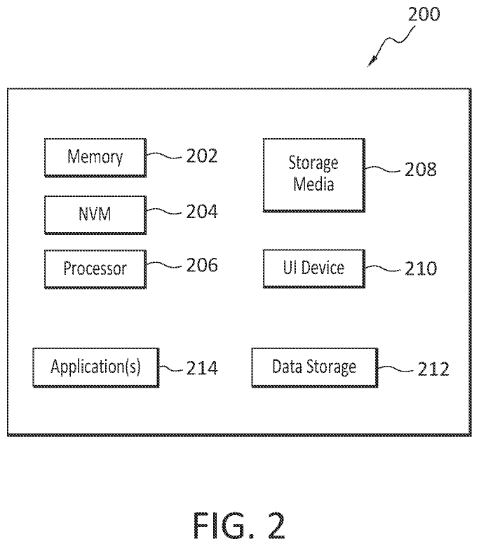

With reference briefly now to FIG. 2, any one or more of the entities disclosed, or implied, by FIG. 1, and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 2.

In the example of FIG. 2, the physical computing device 200 includes a memory 202 which may include one, some, or all, of random access memory (RAM), non-volatile memory (NVM) 204 such as NVRAM for example, read-only memory (ROM), and persistent memory, one or more hardware processors 206, non-transitory storage media 208, UI device 210, and data storage 212. One or more of the memory components 202 of the physical computing device 200 may take the form of solid state device (SSD) storage. As well, one or more applications 214 may be provided that comprise instructions executable by one or more hardware processors 206 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
creating a random matrix Q that defines a benchmark quadratic unconstrained binary optimization problem (QUBO) that has a known, optimal, solution;
transmitting the random matrix Q to each solver in a group that includes multiple solvers;
obtaining, from each of the solvers, a respective solution to the benchmark QUBO problem;
benchmarking the solvers by comparing each of the solutions to the known, optimal solution; and
based on the comparing, identifying a best solver from among the solvers in the group.

2. The method as recited in claim 1, wherein one or more of the solvers comprises a respective annealer.

3. The method as recited in claim 1, wherein the identified solver is used to solve another QUBO problem.

4. The method as recited in claim 1, wherein the random matrix Q has a size N×N, and the known, optimal solution comprises a random binary vector x* of size N.

5. The method as recited in claim 1, wherein a smallest eigenvalue of the matrix Q is equal to a global minima of the Rayleigh quotient.

6. The method as recited in claim 1, wherein creating the random matrix Q comprises:
creating a random binary vector x\hat{ }* of size N as the known, optimal solution;
calculating a null space matrix P of the random binary vector x*;
randomly generating a vector λ of real values with size N in a defined interval, where the real values comprise respective eigenvalues, ordering the entries λ by size, and creating a diagonal matrix Λ=diag(λ);
creating a matrix D with vector x*/x*^{T} x* in a first row of the matrix D, and other null space columns in the matrix D from the null space matrix P, where the matrix D has the form:
$$D = [ \begin{matrix}{x}^{* T} / {x}^{* T} {x}^{*} \\ {P}^{T}\end{matrix} ] ;$$
defining a final QUBO matrix Q=D^{T}ΛD/x*^{T} x*, then using an equivalence of a minimization of the Rayleigh quotient to calculate eₘᵢₙ as follows,
$${e}_{min} = {λ}_{1} / {x}^{* T} {x}^{*} = {min}_{x} {x}^{T} Qx ;$$
wherein eₘᵢₙ is calculated using known values λ₁ and x*^{T} to generate the known optimal solution, and the known optimal solution comprises a solution pair (eₘᵢₙ, x*^{T}).

7. The method as recited in claim 6, wherein calculating the null space matrix P is performed using Gauss-Jordan elimination.

8. The method as recited in claim 1, wherein the best solver is the solver whose solution is closest, relative to the respective solutions of the other solvers in the group, to the known, optimal, solution.

9. A non-transitory storage medium having stored therein instructions that are executable by one or more hardware processors to perform operations comprising:
creating a random matrix Q that defines a benchmark quadratic unconstrained binary optimization problem (QUBO) that has a known, optimal, solution;
transmitting the random matrix Q to each solver in a group that includes multiple solvers;
obtaining, from each of the solvers, a respective solution to the benchmark QUBO problem;
benchmarking the solvers by comparing each of the solutions to the known, optimal solution; and
based on the comparing, identifying a best solver from among the solvers in the group.

10. The non-transitory storage medium as recited in claim 9, wherein one or more of the solvers comprises a respective annealer.

11. The non-transitory storage medium as recited in claim 9, wherein the identified solver is used to solve another QUBO problem.

12. The non-transitory storage medium as recited in claim 9, wherein the random matrix Q has a size N×N, and the known, optimal solution comprises a random binary vector x* of size N.

13. The non-transitory storage medium as recited in claim 9, wherein a smallest eigenvalue of the matrix Q is equal to a global minima of the Rayleigh quotient.

14. The non-transitory storage medium as recited in claim 9, wherein creating the random matrix Q comprises:
creating a random binary vector x\hat{ }* of size N as the known, optimal solution;
calculating a null space matrix P of the random binary vector x*;
randomly generating a vector λ of real values with size N in a defined interval, where the real values comprise respective eigenvalues, ordering the entries λ by size, and creating a diagonal matrix Λ=diag(λ);
creating a matrix D with vector x*/x*^{T} x* in a first row of the matrix D, and other null space columns in the matrix D from the null space matrix P, where the matrix D has the form:
$$D = [ \begin{matrix}{x}^{* T} / {x}^{* T} {x}^{*} \\ {P}^{T}\end{matrix} ] ;$$
defining a final QUBO matrix Q=D^{T}ΛD/x*^{T} x*, then using an equivalence of a minimization of the Rayleigh quotient to calculate eₘᵢₙ as follows,
$${e}_{min} = {λ}_{1} / {x}^{* T} {x}^{*} = {min}_{x} {x}^{T} Qx ;$$
and
wherein eₘᵢₙ is calculated using known values λ₁ and x*^{T} to generate the known optimal solution, and the known optimal solution comprises a solution pair (eₘᵢₙ, x*^{T}).

15. The non-transitory storage medium as recited in claim 14, wherein calculating the null space matrix P is performed using Gauss-Jordan elimination.

16. The non-transitory storage medium as recited in claim 9, wherein the best solver is the solver whose solution is closest, relative to the respective solutions of the other solvers in the group, to the known, optimal, solution.
